(19) United States
(12) Patent Application Publication
(10) Pub. No.: US 2011/0062081 A1
(43) Pub. Date: Mar. 17, 2011

(54) Process for Treating Waste From a Membrane Filtration Plant

(75) Inventors: Catherine Daines-Martinez, Andresy (FR); Jean-Christophe Schrotter, Maisons Laffitte (FR); Karine Drouet, Acheres (FR); Abdelkader Gaid, Paris (FR)

(73) Assignee: VEOLIA WATER SOLUTIONS & TECHNOLOGIES SUPPORT, Saint-Maurice Cedex (FR)

(21) Appl. No.: 12/989,096

(22) PCT Filed: Apr. 24, 2009
(86) PCT No.: PCT/EP09/55004

§ 371 Date: Dec. 7, 2010

(30) Foreign Application Priority Data
Apr. 24, 2008 (FR) 0852769

(51) Int. Cl. C02F 9/04

(52) U.S. Cl. 210/636; 210/638

(57) ABSTRACT

The subject of the invention is a water treatment process, comprising a first pretreatment step that produces pretreated water and sludge, said pretreated water then undergoing at least one membrane filtration step that produces waste and a permeate, said permeate being conveyed to a potabilization system characterized in that said first pretreatment step comprises a first coagulation/flocculation step, and in that said waste resulting from said membrane filtration step undergoes a treatment phase that includes at least one second coagulation/flocculation step followed by a settling step that produces sludge, said settling step being preceded by at least one step of adsorption onto at least one portion of said sludge resulting from the pretreatment and/or onto a portion of said sludge originating from said settling step, said adsorption step targeting a reduction of the phosphonates contained in said waste resulting from said membrane filtration step, said process resulting in treated waste and in excess sludge.

The field of the invention is that of water treatment. More specifically, the invention relates to processes for treating water including at least one membrane filtration step.

The invention applies in particular, but not exclusively, to treatments for water intended to undergo a reverse osmosis or nanofiltration membrane treatment.

The invention preferably applies to water potabilization processes.

Water for human consumption is conventionally subjected to a nanofiltration or reverse osmosis filtration treatment in order to reduce the content of pesticides and other organic micropollutants therein that can be removed by membrane processes.

Nanofiltration also enables bivalent anions, such as sulfates, to be removed, and also enables the content of other salts, such as nitrates, for example, to be reduced.

Reverse osmosis uses membranes similar to those of nanofiltration, but with a greater separation power. It enables almost all organic and inorganic pollutants to be removed from the water. Reverse osmosis is used in particular in the production of water for human consumption.

In addition, it is conventional to subject the water to a pretreatment upstream of the reverse osmosis or nanofiltration membrane treatments, in which said pretreatment consists of a low-speed liquid-solid separation (for example, simple or lamellar settling and/or direct bi-layer filtration, and/or flotation).

A coagulation-flocculation treatment is also frequently performed.

One disadvantage of the membrane filtration techniques is that it produces waste called “concentrates”, representing 10% to 60% of the initial flow, and which are in most cases filled with phosphonates.

These phosphonates come from sequestering agents injected upstream of the membranes. These sequestering agents are intended to prevent the precipitation of salts on the membranes. They are entirely stopped by those thus concentrated at around 2 to 7 times in the membrane waste.

However, the authorities tend to limit or even prohibit phosphonate waste in rivers or the ocean. This problem appears in particular for waste from potable water production plants, some of which is likely to reach rivers or seawater.

It is therefore necessary to provide a technique to prevent such waste.

This is an objective of the invention.

More specifically, the invention is intended to propose a technique for removing undesirable species in filtration waste such as phosphonates, applied to a water treatment including a pretreatment and membrane filtration step.

The invention is also intended to propose such a technique that enables the operating costs to be reduced by comparison with the processes of the prior art.

The invention is also intended to provide a technique that provides optimized reclamation methods for excess sludge.

Another objective of the invention is to provide such a technique with a simple deign that is easy to implement.

The invention also enables waste to be treated in order to upgrade it by using it for cleaning industrial structures such as, for example, sand filters.

These objectives, as well as others, which will be described below, are achieved by the invention, which relates to a water treatment process including a first pretreatment step producing pretreated water and sludge, in which said pretreated water is then subjected to at least one membrane filtration step producing waste and a permeate, in which said permeate is routed to a potabilization system, characterized in that said first pretreatment step includes a first coagulation-flocculation step, and in that said waste from said membrane filtration step undergoes a treatment phase including at least one second coagulation-flocculation step followed by a sedimentation step producing sludge, in which said sedimentation step is preceded by at least one step of adsorption on at least a portion of said sludge resulting from the pretreatment and/or on a portion of said sludge coming from said sedimentation step, in which said adsorption step is intended to eliminate the phosphates contained in said waste resulting from said membrane filtration step, and said process produces treated waste and excess sludge.

It is noted that said first pretreatment step producing pretreated water and sludge will preferably include a so-called primary sedimentation step and/or filtration step on a filter including a filtration medium or on microfiltration or ultrafiltration (MF/UF) membranes, in which the sludge is in the latter two cases produced by back-washings of the filter or microfiltration or ultrafiltration (MF/UF) membranes.

As indicated above, the phosphonates come from the sequestering agents injected upstream of the membranes, concentrated at around 2 to 7 times thereon.

However, as the sequestering agents are chelating agents, they are easily adsorbed on clays, calcites or metal hydroxides, which compounds are classically present in sedimentation sludges. These hydroxides come from iron- or aluminum-based coagulants used in the coagulation step.

The adsorption capacity of the sludges is therefore used to remove the phosphonates of the membrane filtration concentrates.

In addition, the process according to the invention enables the amounts of coagulant to be reduced, and therefore the corresponding operating costs to be reduced.

Indeed, in the case of a conventional coagulation-flocculation of the concentrates, the amount of coagulant is two to three times higher than in the case of the process according to the invention. This is due to the fact that a portion of the phosphonates is adsorbed on the sludge as indicated above. The residual to be eliminated therefore involves a lower consumption of coagulant.

It is noted that the use of sludge for the adsorption step does not lead to significant additional costs, as this sludge is a byproduct of the process according to the invention. Recycling this sludge is therefore inexpensive.

The coagulant is preferably an iron or aluminum salt, and said sludge is iron and/or aluminum hydroxide sludge.

According to another feature, said second coagulation-flocculation step is performed in at least two successive phases, the first under rapid agitation and the second under slow agitation.

According to a preferred embodiment, said adsorption and sedimentation steps are preformed in the same structure, namely a sedimentation tank, preferably for 3 to 90 minutes and most preferably for around 15 minutes. Said adsorption step is performed if necessary under agitation.

According to another feature, the process includes a step of using the excess sludge in land farming.

In this case, the process includes at least one step of concentrating said excess sludge.

In this way, the concentration of phosphorous in the sludge is increased, thereby improving the capacity thereof to fertilize the farming soil. This enrichment of the sludges with phosphorous is a benefit for the agricultural upgrade thereof, as the phosphorous concentration of the sludges enables better fertilization of the farming soil. Moreover, the excess sludge obtained by the process according to the invention is rich in phosphonates. However, the phosphorous in the form of phosphonates is less accessible to plants than the phosphorous in the form of phosphate. The phosphorous degradation thereof will therefore be slower, and therefore more beneficial for the soil.

Other features and advantages of the invention will become clearer on reading the following description of a preferred embodiment of the invention, provided by way of an illustrative and non-limiting example, and the appended drawings in which:

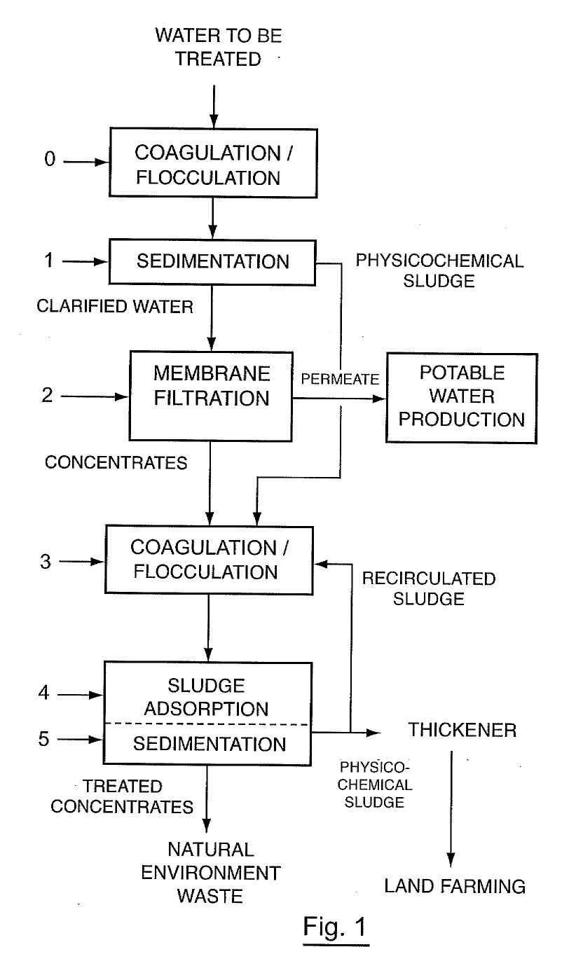

FIG. 1 is a synoptic representation of a water treatment process according to the invention;

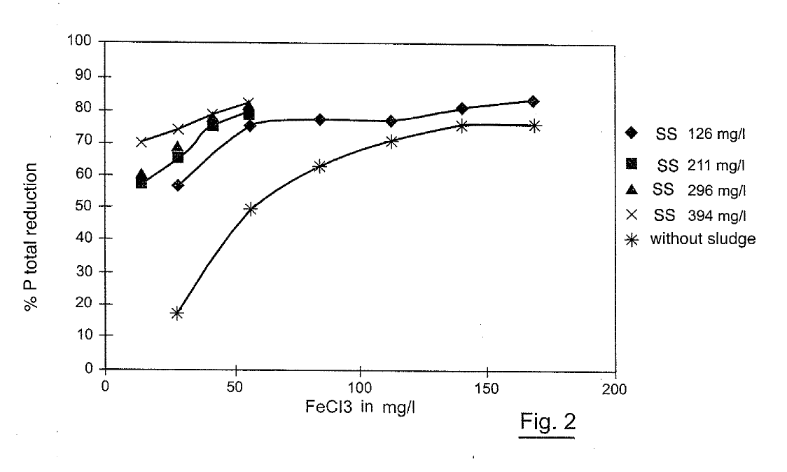

FIG. 2 is a graph of the elimination of phosphorus in membrane concentrates with different amounts of sludge.

In reference to FIG. 1, the example relates to a water treatment process for potabilization, which includes, according to the invention, a pretreatment step and at least one membrane filtration step, a step of removing the phosphonates present in the membrane filtration concentrates by adsorption on the sludges resulting from the pretreatment.

As shown in FIG. 1, the water to be treated undergoes a primary sedimentation step 1 preceded by a first coagulation/flocculation step, at the end of which a clarified water and a physicochemical sludge are obtained.

The clarified water is then subjected to a membrane filtration step 2, by nanofiltration or reverse osmosis, at the end of which the permeate obtained is routed to a potable water production unit.

According to the invention, the membrane treatment concentrates are then subjected to a treatment phase including a second coagulation/flocculation step 3 and a so-called secondary sedimentation step 5, at the end of which a treated concentrate and sedimentation sludge are obtained.

According to the invention, a phosphonate adsorption step 4 is inserted between the second coagulation/flocculation step 3 and the sedimentation step 5.

This adsorption step is performed for 10 minutes, under agitation, with an agitation speed of 60 rpm, on the sludge resulting from the primary sedimentation step 1 and on a portion of the sludge resulting from the secondary sedimentation step 5, in which the excess sludge coming from said step is thickened, then upgraded by land farming.

The second coagulation/flocculation step 3 is broken down into two phases: a first phase under rapid agitation at 250 rpm, then a second phase under slow agitation at 60 rpm.

The coagulant is inorganic, preferably FeCl₃, with a concentration ranging from 1 to 200 mg/l.

The flocculent is of the 4190 SH Floerger type (registered trademark), with a concentration of between 0.05 and 1 ppm.

The duration of the sedimentation steps 1 and 5 is 15 minutes for each.

To show the efficacy of the process, primary sedimentation sludges coming from a potable water treatment plant and having different concentrations of suspended solids were placed in contact with the concentrates of the membrane filtration unit of said potable water treatment plant, after having subjected said concentrates to a second coagulation/flocculation step.

In practice, the sludges tested had a suspended solids concentration of between 126 mg/l and 394 mg/l.

The phosphonate elimination rate of these concentrates was assessed according to the total phosphorus elimination (Pₜₒₜₐₗ) in the concentrates treated.

The results obtained were compared to those obtained by an identical process, but not including the step consisting according to the invention of placing the concentrates having undergone a second coagulation/flocculation steps in contact with the primary sedimentation sludges coming from the potable water treatment station.

For better reliability of the analyses, the elimination of phosphonates was determined according to the total phosphorous elimination (Pₜₒₜₐₗ).

The results of these tests are presented in the graph of FIG. 2.

It is observed that, for the same percentage of total phosphorous elimination Pₜₒₜₐₗ, the coagulant (FeCl₃) doses used are more reliable when an adsorption step is performed according to the invention.

Thus, to remove 75% of the total phosphorous, it is necessary to use 60 ppm of FeCl₃ with sludge at 126 mg/l (suspended solids) by comparison with 150 ppm of FeCl₃ without the adsorption step.

1-8. (canceled)

9. A method for reducing phosphonates in a water treatment process, the method comprising:
directing water to be treated to a first sedimentation zone and separating the water to be treated into clarified water and sludge in the first sedimentation zone;
directing the clarified water from the first sedimentation zone to a filtration membrane and separating the clarified water into a permeate and an untreated concentrate with the filtration membrane, wherein the untreated concentrate contains phosphonates;
directing the permeate to a potable water production zone;
mixing the sludge from the first sedimentation zone with the untreated concentrate and adsorbing the phosphonates from the untreated concentrate onto the sludge producing a treated concentrate and sludge having adsorbed phospohonates thereon; and
separating the sludge having adsorbed phosphonates thereon from the treated concentrate in a second sedimentation zone.

10. The method of claim 9 further comprising directing at least a first portion of the separated sludge having adsorbed phosphonates thereon from the second sedimentation zone and mixing the first portion of sludge with the untreated concentrate phosphonates from the filtration membrane.

11. The method of claim 10 further comprising directing at least a second portion of the separated sludge having adsorbed phosphonates thereon from the second sedimentation zone to a thickener for further concentration.

12. The method of claim 9 further comprising adding a coagulant and a flocculant to water to be treated prior to directing the water to be treated to the first sedimentation zone.

13. The method of claim 9 further comprising adding a coagulant and a flocculant to the untreated concentrate from the filtration membrane.

14. The method of claim 12 wherein the coagulant is a first coagulant and the flocculant is a first flocculant and the method further comprises adding a second coagulant and a second flocculant to the untreated concentrate from the filtration membrane.

15. The method of claim 10 further comprising adsorbing phosphonates in the untreated concentrate onto the first portion of sludge when the first portion of sludge is mixed with the untreated concentrate.

16. The method of claim 9 wherein the filtration membrane is a nanofiltration membrane or a reverse osmosis membrane.

17. The method of claim 9 further comprising adding sequestering agents containing phosphonates to the water to be treated prior to directing the water to be treated to the first sedimentation zone.

18. The method of claim 17 wherein the sludge from the first sedimentation zone contains clays, calcites, or metal hydroxides.

19. The method of claim 13 wherein the coagulant is either an iron salt or an aluminum salt and the sludge from the first sedimentation zone contains either iron hydroxides or aluminum hydroxides.

20. The method of claim 19 wherein the coagulant is FeCl₃ and has a concentration in the range of approximately 1 mg/l to approximately 200 mg/l.

21. The method of claim 11 wherein after the second portion of sludge is directed to the thickener for further concentration, the second portion of sludge has an increased concentration of phosphonates relative to the first portion of sludge.

22. The method of claim 21 wherein after the second portion of sludge is further concentrated in the thickener, the second portion of sludge is used to fertilize soil.

23. The method of claim 9 wherein the sludge from the first sedimentation zone and the untreated concentrate from the filtration membrane are mixed for approximately 10 minutes at a speed of approximately 60 rpms.

24. The method of claim 10 wherein the untreated concentrate from the filtration membrane is mixed with the sludge from the first sedimentation zone and the first portion of sludge having adsorbed phosphonates thereon simultaneously.

25. The method of claim 13 wherein the sludge from the first sedimentation zone is mixed with the untreated concentrate, the coagulant, and the flocculant at a first relatively fast rate and then at a second relatively slow rate.

26. The method of claim 25 wherein the first relatively fast rate is approximately 250 rpms and the second relatively slow rate is approximately 60 rpms.

27. The method of claim 13 wherein the flocculant is 4190 SH Floeger® type having concentration of between approximately 0.05 ppm and approximately 1 ppm.

28. The method of claim 9 wherein separating the water to be into clarified water and sludge in the first sedimentation zone occurs for approximately 15 minutes and separating the sludge having adsorbed phosphonates thereon from the treated concentrate in a second sedimentation zone occurs for approximately 15 minutes.

29. The method of claim 13 wherein the coagulant has a concentration of approximately 60 ppm and the sludge from the first sedimentation zone has a concentration of approximately 126 mg/l and wherein at least 75% of the phosphonates in the untreated concentrate are adsorbed onto the sludge from the first sedimentation zone to produce the treated concentrate.

30. The method of claim 9 wherein mixing the sludge from the first sedimentation zone with the untreated concentrate and adsorbing the phosphonates in the untreated concentrate onto the sludge from the first sedimentation zone occurs in the second sedimentation zone.

31. The method of claim 30 wherein the sludge from the first sedimentation zone is mixed with the untreated concentrate, the phosphonates from the untreated concentrate are adsorbed onto the sludge, and sludge having adsorbed phosphonates thereon is separated from the treated concentrate simultaneously in a second sedimentation zone for between approximately 3 minutes and approximately 90 minutes.

32. The method of claim 31 wherein the sludge from the first sedimentation zone is mixed with the untreated concentrate, the phosphonates from the untreated concentrate are adsorbed onto the sludge, and sludge having adsorbed phosphonates thereon is separated from the treated concentrate simultaneously in a second sedimentation zone for between approximately 15 minutes.

33. A method for reducing phosphonates in a water treatment process, the method comprising:
directing water to be treated to a first separation zone and producing clarified water and sludge, wherein the first separation zone includes a first filtration membrane;
directing the clarified water from the first separation zone to a second filtration membrane and separating the clarified water into a permeate and an untreated concentrate, wherein the untreated concentrate contains phosphonates;
mixing the sludge from the first separation zone with the untreated concentrate and adsorbing the phosphonates in the untreated concentrate onto the sludge producing a treated concentrate and sludge having adsorbed phosphonates thereon; and
separating the sludge having adsorbed phosphonates thereon from the treated concentrate in a second separation zone.

34. The method of claim 33 further comprising mixing at least a first portion of the separated sludge having adsorbed phosphonates thereon from the second separation zone with the untreated concentrate from the second filtration membrane.

35. The method of claim 33 wherein the first separation zone includes a first sedimentation zone and the first filtration membrane, wherein first filtration membrane is either a microfiltration membrane or an ultrafiltration membrane.

36. The method of claim 33 further comprising backwashing the first filtration membrane to produce at least a portion of the sludge in the first separation zone.

37. The method of claim 33 wherein mixing the sludge from the first separation zone with the untreated concentrate, adsorbing the phosphonates in the untreated concentrate onto the sludge, and separating the sludge having adsorbed phosphonates thereon from the treated concentrate occurs simultaneously in the same tank.

38. The method of claim 37 wherein mixing of the sludge from the first separation zone with the untreated concentrate, adsorbing the phosphonates in the untreated concentrate onto the sludge, and separating the sludge having adsorbed phosphonates thereon from the treated concentrate occurs for between approximately 3 minutes and approximately 90 minutes.

39. The method of claim 38 wherein mixing of the sludge from the first separation zone with the untreated concentrate, adsorbing the phosphonates in the untreated concentrate onto the sludge, and separating the sludge having adsorbed phosphonates thereon from the treated concentrate occurs for approximately 15 minutes.

40. The method of claim 33 further comprising adding a coagulant and a flocculant to water to be treated prior to directing the water to be treated to the first separation zone.

41. The method of claim 33 further comprising adding a coagulant and a flocculant to the untreated concentrate.

42. The method of claim 40 wherein the coagulant is a first coagulant and the flocculant is a first flocculant and the method further comprises adding a second coagulant and a second flocculant to the untreated concentrate.

43. The method of claim 34 further comprising adsorbing phosphonates in the untreated concentrate onto the first portion of sludge when the first portion of sludge is mixed with the untreated concentrate.

44. The method of claim 33 wherein the second filtration membrane is a nanofiltration membrane or a reverse osmosis membrane.

45. The method of claim 33 further comprising adding sequestering agents containing phosphonates to the water to be treated prior to directing the water to be treated to the first separation zone.

46. The method of claim 34 further comprising direct at least a second portion of the separated sludge having adsorbed phosphonates thereon from the second separation zone to a thickener for further concentration, and wherein after the second portion of sludge is directed to the thickener, the second portion of sludge has an increased concentration of phosphonates relative to the first portion of sludge.

47. The method of claim 33 wherein the sludge from the first separation zone and the untreated concentrate from the filtration membrane are mixed for approximately 10 minutes at a speed of 60 rpms.

48. The method of claim 41 wherein the sludge from the first separation zone is mixed with the untreated concentrate, the coagulant, and the flocculant at a first rate of approximately 250 rpms and then at a second rate of 60 rpms.

49. The method of claim 41 wherein the coagulant has a concentration of approximately 60 ppm and the sludge from the first separation zone has a concentration of approximately 126 mg/l and wherein at least 75% of the phosphonates in the untreated concentrate are adsorbed onto the sludge to produce the treated concentrate.

50. A method of treating drinking water and removing phosphonates during the treatment, comprising:
subjecting the water to pretreatment by mixing a coagulant and a flocculant with the water and through a separation process producing clarified water and sludge;
directing the clarified water to a membrane filter and separating the clarified water into a permeate and a concentrate where the concentrate includes phosphonates;
directing the permeate to a potable water production unit for producing potable water;
mixing the sludge with the concentrate that is produced by the membrane filter;
adsorbing the phosphonates in the concentrate onto the sludge to produce a treated concentrate and sludge having the phosphonates adsorbed thereon; and
separating the treated concentrate from the sludge having the phosphonates adsorbed thereon.

51. The method of claim 50 further including mixing a coagulant and a flocculant with the mixture of sludge and concentrate from the membrane filter.

52. The method of claim 50 including recirculating at least a portion of the sludge having the phosphonates adsorbed thereon and mixing the sludge having the phosphonates adsorbed thereon with the concentrate.

53. The method of claim 50 wherein adsorbing the phosphonates in the concentrate onto the sludge includes agitating the mixture of concentrate and sludge.

54. The method of claim 53 wherein agitating the mixture of concentrate and sludge is performed in at least two phases, a first phase where the agitation is relatively rapid and a second phase where the agitation is relatively slow.
